(19) United States
(12) Patent Application Publication
(10) Pub. No.: US 2014/0201248 A1
(43) Pub. Date: Jul. 17, 2014

(54) METHOD AND APPARATUS FOR REPRESENTING BUBBLE EFFECT USING METADATA

(71) Applicants: Seung Jun YANG, Daejeon-si (KR); Sang Kyun KIM, Seongnam-si (KR); Yong Soo JOO, Seoul (KR)

(72) Inventors: Seung Jun YANG, Daejeon-si (KR); Sang Kyun KIM, Seongnam-si (KR); Yong Soo JOO, Seoul (KR)

(73) Assignees: Myongji University Industry and Academia Cooperation Foundation, Yongin-si (KR); ELECTRONICS AND TELECOMMUNICATIONS RESEARCH INSTITUTE, Daejeon-si (KR)

(21) Appl. No.: 14/153,763

(22) Filed: Jan. 13, 2014

(30) Foreign Application Priority Data
Jan. 16, 2013 (KR) 10-2013-0004728
Jan. 9, 2014 (KR) 10-2014-0002678

(51) Int. Cl. G06F 17/30

(52) U.S. Cl. CPC G06F 17/30289
USPC 707/803

(57) ABSTRACT

Disclosed herein are a method and apparatus for representing a bubble effect using metadata. The method for representing a bubble effect using a bubble effect representation apparatus may include generating metadata based on information related to a bubble effect, information about the performance of the bubble effect representation apparatus, and preference information for the bubble effect, generating control instruction information for the bubble effect representation apparatus by analyzing the generated metadata, and representing the bubble effect based on the control instruction information.

Priority to Korean patent application numbers 2013-0004728 filed on Jan. 16, 2013 and 2014-0002678 filed on Jan. 9, 2014, the entire disclosures of which are incorporated by reference herein.

### BACKGROUND OF THE INVENTION

1. Field of the Invention

Embodiments of the present invention relate to a method and apparatus for defining and representing a bubble effect using metadata.

2. Discussion of the Related Art

Today, the sensory media (4-D media) industry to which effects for producing more realistic media content by stimulating the human's five senses using vibration, the wind, water vapor, scent, and lighting have been added begins to become active in earnest.

In general, a sensory effect of sensory media is represented based on metadata that is additionally provided along with existing media content. For example, Korean Patent Laid-Open Publication No. 10-2012-0090565 (Aug. 17, 2012) entitled “Apparatus for Processing Sensory Effect of Image Data and Method for the Same” discloses that information about the depth of an object included in an image and data for texture are analyzed, a behavior of a user is analyzed, the behavior of the user is matched with the image, and the image matched with the behavior of the user and the texture of the object coming in contact with the body of the user are outputted to the body of the user.

Such an existing method, however, is problematic in that a bubble effect capable of producing a happy atmosphere, an amazing feeling, or a festive mood cannot be represented because a bubble effect has not been defined although a motion or behavior of a user can be reflected when representing a sensory effect.

### SUMMARY OF THE INVENTION

An object of the present invention is to provide a method for representing a bubble effect which can effectively representing a bubble effect capable of producing various atmospheres when playing back media content.

Another object of the present invention is to provide an apparatus for representing a bubble effect which can effectively representing a bubble effect capable of producing various atmospheres when playing back media content.

In accordance with an aspect of the present invention, a method for representing a bubble effect using a bubble effect representation apparatus may include generating metadata based on information related to a bubble effect, information about the performance of the bubble effect representation apparatus, and preference information for the bubble effect, generating control instruction information for the bubble effect representation apparatus by analyzing the generated metadata, and representing the bubble effect based on the control instruction information.

In accordance with an aspect of the present invention, the information related to the bubble effect may include at least one of information about whether or not the bubble effect is used and a playback time of the bubble effect.

In accordance with another aspect, the generating of the metadata may include generating first metadata for the bubble effect based on the information related to the bubble effect, generating second metadata for the performance of the bubble effect representation apparatus based on the information about the performance of the bubble effect representation apparatus, and third metadata related to a user's preference information for the bubble effect based on the preference information for the bubble effect.

In accordance with yet another aspect, the first metadata may include information about the intensity of the bubble effect and range information for the intensity of the bubble effect.

In accordance with yet another aspect, the second metadata may include information about whether or not the bubble effect is able to be represented.

In accordance with yet another aspect, the third metadata may include information about whether or not the bubble effect is used according to the user's preference information for the bubble effect.

In accordance with yet another aspect, the generating of the control instruction information may include combining the first metadata, the second metadata, and the third metadata and generating the control instruction information by analyzing the combined first metadata, second metadata, and third metadata.

In accordance with yet another aspect, the representing of the bubble effect may include generating the metadata for control of the bubble effect representation apparatus based on the control instruction information and analyzing the metadata for control of the bubble effect representation apparatus and converting the analyzed metadata into a driving signal for driving the bubble effect representation apparatus.

In accordance with yet another aspect, a bubble effect representation apparatus may include an analysis unit for generating metadata generated based on information related to a bubble effect, information about the performance of the bubble effect representation apparatus, and preference information for the bubble effect, a generation unit for generating control instruction information for the bubble effect representation apparatus based on a result of the analysis of the analysis unit, and a representation unit for representing the bubble effect based on the control instruction information.

In accordance with yet another aspect, an apparatus for generating control of a bubble effect representation apparatus may include a generation unit for generating first metadata for a bubble effect based on information related to the bubble effect, generating second metadata for the performance of the bubble effect representation apparatus based on information about the performance of the bubble effect representation apparatus, and generating third metadata related to a user's preference information for the bubble effect based on preference information for the bubble effect and an analysis unit for combining the first metadata, the second metadata, and the third metadata and analyzing the combined metadata, wherein the generation unit generates metadata for control of the bubble effect representation apparatus based on a result of the analysis of the analysis unit.

### BRIEF DESCRIPTION OF THE DRAWINGS

FIG. 1 is a flowchart illustrating a method for representing a bubble effect in accordance with an embodiment of the present invention;

FIG. 2 is a diagram illustrating bubble effect information metadata in accordance with an embodiment of the present invention;

FIG. 3 is a diagram illustrating bubble effect representation apparatus performance information metadata in accordance with an embodiment of the present invention;

FIG. 4 is a diagram illustrating bubble effect preference information metadata in accordance with an embodiment of the present invention;

FIG. 5 is a diagram illustrating bubble effect representation apparatus control instruction information metadata in accordance with an embodiment of the present invention; and

FIG. 6 is a block diagram showing an apparatus for representing a bubble effect in accordance with an embodiment of the present invention.

### DETAILED DESCRIPTION OF THE EMBODIMENTS

Hereinafter, embodiments of the present invention are described in detail with reference to the accompanying drawings so that they can be readily implemented by those skilled in the art. The present invention may be implemented in various ways and is not limited to the following embodiments.

Furthermore, in the drawings, a description of parts not related to the present invention is omitted in order to clarify the present invention, and similar reference numerals are used to denote similar elements throughout the specification.

In the entire specification, unless explicitly described to the contrary, the word “comprise” and variations, such as “comprises” or “comprising”, will be understood to imply the inclusion of stated elements but not the exclusion of any other elements. Furthermore, the term “ . . . unit” described in the specification means a unit for processing at least one function or operation, and the unit may be implemented by hardware or software or a combination of hardware and software.

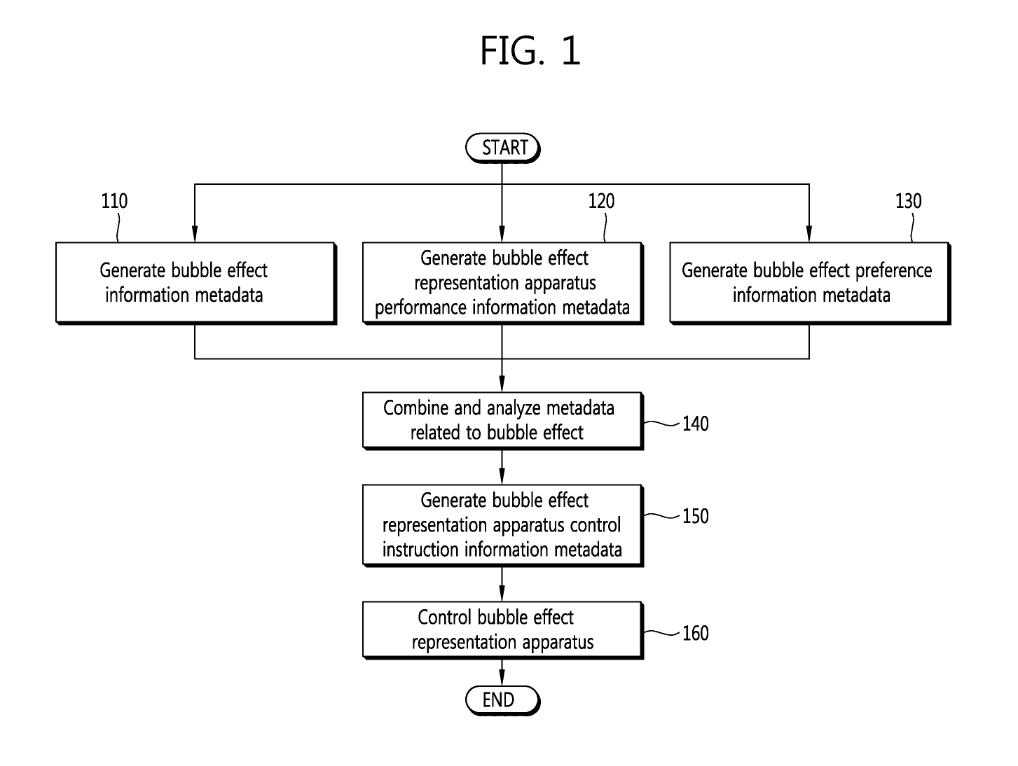

FIG. 1 is a flowchart illustrating a method for representing a bubble effect in accordance with an embodiment of the present invention.

An apparatus for representing a bubble effect (hereinafter also called a ‘bubble effect representation apparatus’) according to the present invention generates metadata based on information related to a bubble effect, information about the performance of the bubble effect representation apparatus, and preference information for the bubble effect. Furthermore, the bubble effect representation apparatus generates bubble effect representation apparatus control instruction information by analyzing the generated metadata and represents a bubble effect based on the control instruction information. To this end, for example, the bubble effect representation apparatus may generate bubble effect information metadata (hereinafter referred to as ‘first metadata’) based on information related to a bubble effect at step 110, generate bubble effect representation apparatus performance information metadata (hereinafter referred to as ‘second metadata’) based on performance information for the bubble effect representation apparatus at step 120, and generate bubble effect preference information metadata (hereinafter referred to as ‘third metadata’) based on preference information for the bubble effect at step 130. The information related to the bubble effect may include at least one of information about whether or not the bubble effect is used and the playback time of the bubble effect.

The first metadata may include information about the intensity of the bubble effect, range information for the intensity of the bubble effect, information about the playback time of the bubble effect, information about the duration of the bubble effect, and so on. The second metadata may include information about whether or not the bubble effect can be represented. Furthermore, the third metadata may include information about whether or not the bubble effect is used according to a user's preference information for the bubble effect.

The bubble effect representation apparatus according to the present invention generates control instruction information by combining and analyzing the metadata (i.e., the first metadata, the second metadata, and the third metadata) related to the bubble effect at step 140. Furthermore, the bubble effect representation apparatus generates bubble effect representation apparatus control instruction information metadata for control of the bubble effect representation apparatus based on the control instruction information at step 150. Thereafter, the bubble effect representation apparatus analyzes the metadata for control of the bubble effect representation apparatus, converts the analyzed metadata into a driving signal for driving the bubble effect representation apparatus, and controls the representation of the bubble effect using the converted driving signal at step 160.

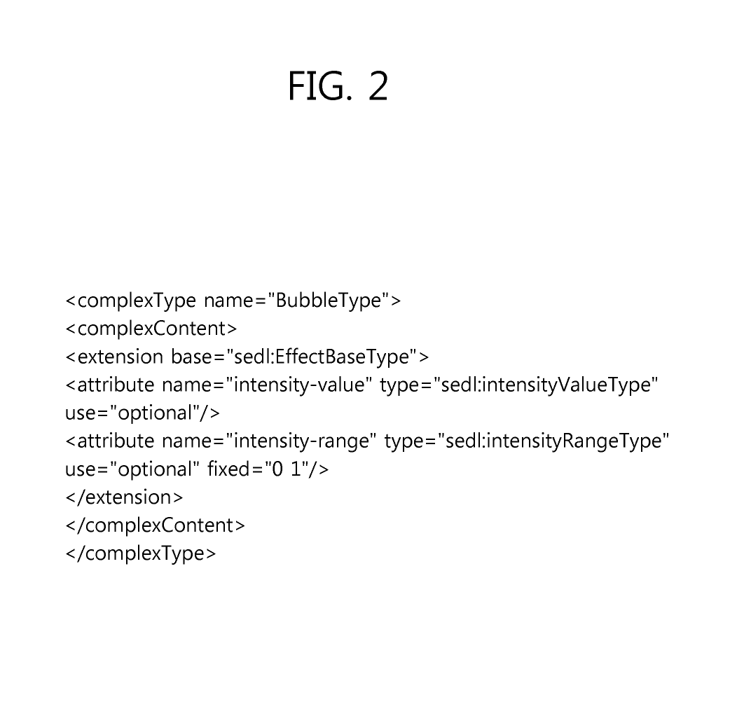

FIGS. 2 to 5 are diagrams illustrating bubble effect information metadata, bubble effect representation apparatus performance information metadata, bubble effect preference information metadata, and bubble effect representation apparatus control instruction information metadata, respectively, in accordance with embodiments of the present invention. The metadata is described in more detail with reference to FIGS. 2 to 5.

In general, metadata is represented in the form of an eXtensible Markup Language (XML) form. However, metadata according to the present invention can become binary as in FIGS. 2 to 5 for the purpose of high-speed data transmission and data compression.

For example, as shown in FIG. 2, bubble effect information metadata can be defined through the extension of “EffectBaseType” defined in ISO/IEC 230005-3. Accordingly, the bubble effect information metadata may include basic attributes defined in “EffectBaseType”. Furthermore, the bubble effect information metadata may be used as one type of “effect” metadata defined in ISO/IEC 230005-3. The bubble effect information metadata can become binary based on Table 1 below.

TABLE 1

| BubbleType { | Number of bits | Mnemonics |
|---|---|---|
| EffectBaseType | | EffectBaseType |
| intensityValueFlag | 1 | bslbf |
| intensityRangeFlag | 1 | bslbf |
| if(intensityValueFlag) { | | |
| intensityValue | 32 | fsfb |
| } | | |
| if(intensityRangeFlag) { | | |
| intensityRange[0] | 32 | fsfb |
| intensityRange[1] | 32 | fsfb |
| } | | |
| } | | |

Referring to Table 1, a field “intensityValueFlag” indicating the existence of attributes “intensityValue” and a field “intensityValueFlag” indicating the existence of attributes “intensityRange” can be added to the binary bubble effect metadata. Accordingly, attributes “intensity-value” that describes information about the intensity of a bubble effect is present when a value of the field “intensityValueFlag” is 1 and is not present when a value of the field “intensityValueFlag” is 0. Likewise, attributes “intensity-range” that describes range information for the intensity of a bubble effect is present when a value of a field “intensityRangeFlag” is 1 and is not present when a value of the field “intensityRangeFlag” is 0. The attributes “intensityValue” and “intensityRange” can indicate respective bubble effects and the on/off of a bubble effect range through ‘1’ and ‘0’.

For example, if binary bubble effect metadata is <sedl:Effect xsi:type=“sev:BubbleType” intensity-value=“1” intensity-range=“0 1” duration=“5” si:pts=“0”/>, it indicates that a bubble effect is represented in a range of 1 (on) and 0 (Off) for 5 seconds starting from si:pts=“0”.

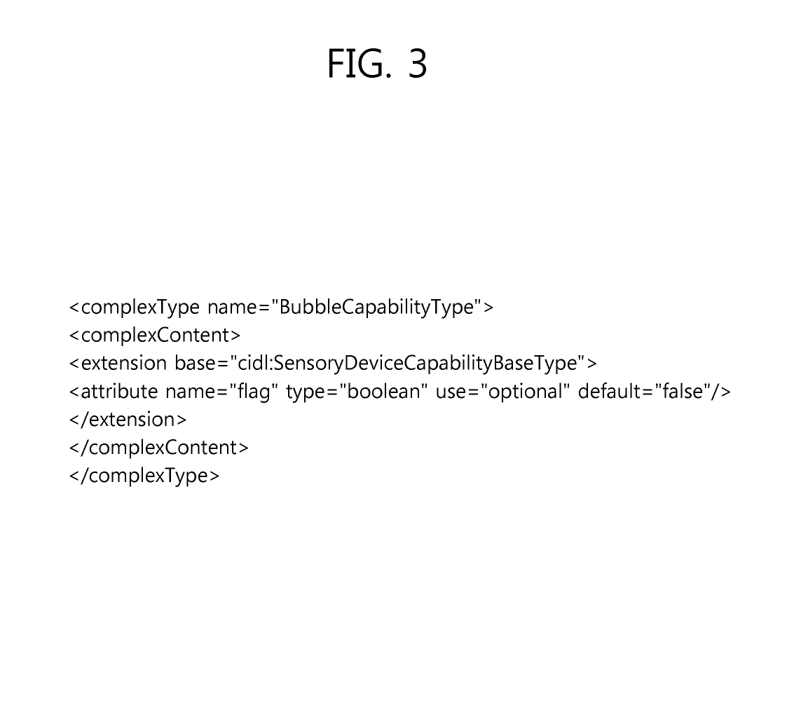

Meanwhile, bubble effect representation apparatus performance information metadata can be defined through the extension of “SensoryDeviceCapabilityBaseType” defined in ISO/IEC 230005-2 as in FIG. 3. Accordingly, the bubble effect representation apparatus performance information metadata may include basic attributes defined in “SensoryDeviceCapabilityBaseType”. Furthermore, the bubble effect representation apparatus performance information metadata may be used as one type of metadata “SensoryDeviceCapability” in ISO/IEC 230005-2. The bubble effect representation apparatus performance information metadata can become binary based on Table 2 below.

TABLE 2

| | Number | |
|---|---|---|
| BubbleCapabilityType { | of bits | Mnemonics |
| flagFlag | 1 | bslbf |
| SensoryDeviceCapabilityBase | | SensoryDeviceCapabilityBase |
| | | Type |
| if(flagFlag) { | | |
| flag | 1 | bslbf |
| } | | |
| } | | |

Referring to Table 2, a field ‘flagFlag’ can be added to the binary bubble effect representation apparatus performance information metadata. The field ‘flagFlag’ may be present as a binary expression, and it indicates the existence of activation attributes. When a value of the field ‘flagFlag’ is 1, it indicates that activation attributes are used. When a value of the field ‘flagFlag’ is 0, it indicates that activation attributes are not used. Furthermore, the bubble effect representation apparatus performance information metadata may include flag attributes that describe whether bubble effect representation apparatus performance is present or not. For example, if binary bubble effect representation apparatus performance information metadata is <cidl:SensoryDeviceCapability xsi :type=“dcdv:BubbleCapabilityType” flag=“true” id=“bubble1”/>, it indicates that the bubble effect representation apparatus has a bubble effect representation function because the flag attributes is ‘true’.

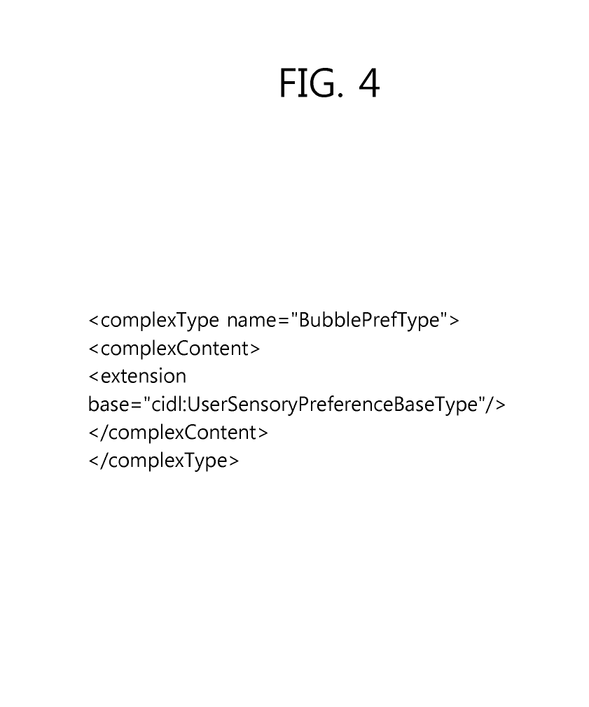

Meanwhile, bubble effect preference information metadata can be defined through the extension of “UserSensoryPreferenceBaseType” defined in ISO/IEC 230005-2 as in FIG. 4. Accordingly, the bubble effect preference information metadata may include basic attributes defined in “UserSensoryPreferenceBaseType”. Furthermore, the bubble effect preference information metadata may be used as one type of metadata “USPreference” in ISO/IEC 230005-2. The bubble effect preference information metadata can become binary based on Table 3 below.

TABLE 3

| | Number | |
|---|---|---|
| BubblePrefType { | of bits | Mnemonics |
| UserSensoryPreferenceBase | | UserSensoryPreferenceBaseType |
| } | | |

Referring to Table 3, the binary bubble effect preference information metadata may include attributes “UserSensoryPreferenceBase”. A user can designate whether he or she prefers the use of the bubble function of the bubble effect representation apparatus using the attributes “UserSensoryPreferenceBase”. In this case, all pieces of information given by other attributes may be neglected. For example, if bubble effect preference information metadata is <cidl:USPreference xsi:type=“sepv:BubblePrefType” activate=“true”/>, it may indicate that a user requests the representation of a bubble effect.

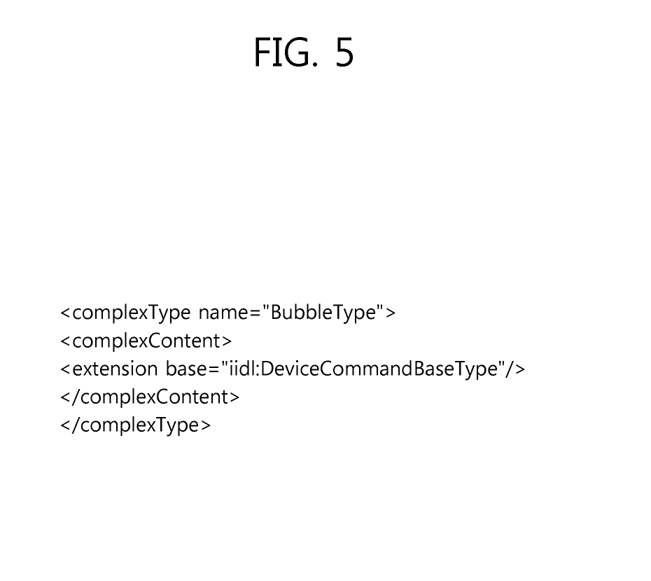

Meanwhile, bubble effect representation apparatus instruction information metadata can be defined through the extension of “DeviceCommandBaseType” defined in ISO/IEC 230005-5 as in FIG. 5. The bubble effect representation apparatus instruction information metadata can become binary based on Table 4 below, for example. Accordingly, the binary bubble effect representation apparatus instruction information metadata may include basic attributes defined in “DeviceCommandBaseType”. Furthermore, the binary bubble effect representation apparatus instruction information metadata may be used as one type of metadata “DeviceCommand” in ISO/IEC 230005-5.

TABLE 4

| | Number | |
|---|---|---|
| BubbleType { | of bits | Mnemonics |
| DeviceCommandBase | | DeviceCommandBaseType |
| } | | |

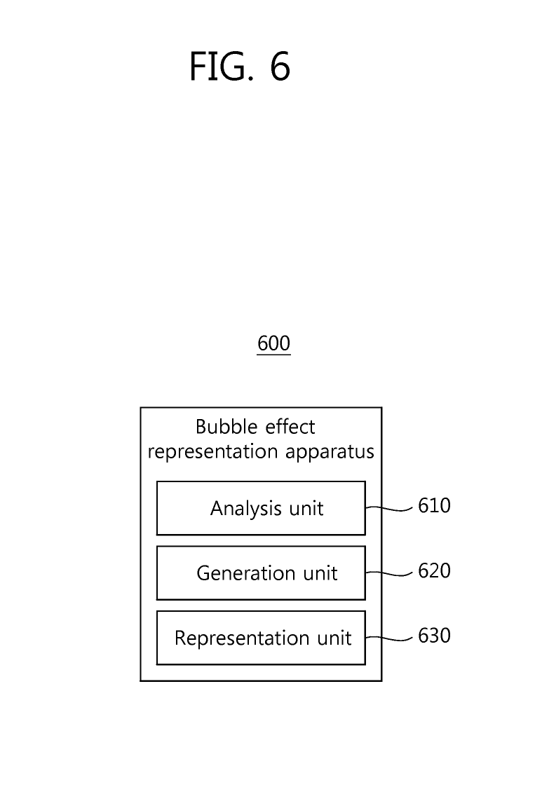

FIG. 6 is a block diagram showing a bubble effect representation apparatus in accordance with an embodiment of the present invention.

Referring to FIG. 6, the bubble effect representation apparatus 600 in accordance with an embodiment of the present invention includes an analysis unit 610, a generation unit 620, and a representation unit 630.

The analysis unit 610 analyzes metadata generated based on information related to a bubble effect, information about the performance of the bubble effect representation apparatus 600, and preference information for the bubble effect. The information related to the bubble effect may include at least one of information about whether or not the bubble effect is used and the playback time of the bubble effect.

Furthermore, the analysis unit 610 may receive first metadata generated based on information related to a bubble effect, second metadata generated based on information about the performance of the bubble effect representation apparatus 600, and third metadata generated based on preference information for the bubble effect, combine the first metadata, the second metadata, and the third metadata, and analyze the combined metadata. Here, the first metadata may include information about the intensity of the bubble effect and range information for the intensity of the bubble effect. The second metadata may include information about whether or not the bubble effect can be represented. The third metadata may include information about whether or not the bubble effect is used according to a user's preference information for the bubble effect.

The generation unit 620 generates control instruction information for the bubble effect representation apparatus 600 based on a result of the analysis of the analysis unit 610 or generates metadata for control of the bubble effect representation apparatus 600 based on the control instruction information.

The representation unit 630 represents a bubble effect based on the control instruction information generated from the generation unit 620 or represents a bubble effect by analyzing the metadata for control of the bubble effect representation apparatus 600 generated from the generation unit 620 and driving the bubble effect representation apparatus 600 based on a result of the analysis.

Meanwhile, the metadata for control of the bubble effect representation apparatus may be generated from an additional metadata generation apparatus (not shown) and then inputted to the bubble effect representation apparatus 600. In such a case, the additional metadata generation apparatus may include a generation unit for generating first metadata for a bubble effect based on information related to a bubble effect, generating second metadata for the performance of the bubble effect representation apparatus 600 based on the information about the performance of the bubble effect representation apparatus, and generating third metadata related to a user's preference information for the bubble effect based on preference information for the bubble effect and an analysis unit for combining the first metadata, the second metadata, and the third metadata and analyzing the combined metadata.

The generation unit of the additional metadata generation apparatus may generate metadata for control of the bubble effect representation apparatus 600 based on a result of the analysis of the analysis unit of the additional metadata generation apparatus and provide the generated metadata to the bubble effect representation apparatus 600. In this case, the bubble effect representation apparatus 600 may represent a bubble effect by analyzing the metadata for control of the bubble effect representation apparatus that has been generated from the additional metadata generation apparatus.

As described above, various atmospheres can be effectively produced when playing back media content because a bubble effect is defined using metadata, and a bubble effect is represented using the defined bubble effect.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A method for representing a bubble effect using a bubble effect representation apparatus, the method comprising:
generating metadata based on information related to a bubble effect, information about a performance of the bubble effect representation apparatus, and preference information for the bubble effect;
generating control instruction information for the bubble effect representation apparatus by analyzing the generated metadata; and
representing the bubble effect based on the control instruction information.

2. The method of claim 1, wherein the information related to the bubble effect comprises at least one of information about whether or not the bubble effect is used and a playback time of the bubble effect.

3. The method of claim 1, wherein the generating of the metadata comprises:
generating first metadata for the bubble effect based on the information related to the bubble effect;
generating second metadata for the performance of the bubble effect representation apparatus based on the information about the performance of the bubble effect representation apparatus; and
third metadata related to a user's preference information for the bubble effect based on the preference information for the bubble effect.

4. The method of claim 3, wherein the first metadata comprises information about an intensity of the bubble effect and range information for the intensity of the bubble effect.

5. The method of claim 3, wherein the second metadata comprises information about whether or not the bubble effect is able to be represented.

6. The method of claim 3, wherein, the third metadata comprises information about whether or not the bubble effect is used according to the user's preference information for the bubble effect.

7. The method of claim 3, wherein the generating of the control instruction information comprises:
combining the first metadata, the second metadata, and the third metadata; and
generating the control instruction information by analyzing the combined first metadata, second metadata, and third metadata.

8. The method of claim 1, wherein the representing of the bubble effect comprises:
generating the metadata for control of the bubble effect representation apparatus based on the control instruction information; and
analyzing the metadata for control of the bubble effect representation apparatus and converting the analyzed metadata into a driving signal for driving the bubble effect representation apparatus.

9. A bubble effect representation apparatus, comprising:
an analysis unit for generating metadata generated based on information related to a bubble effect, information about a performance of the bubble effect representation apparatus, and preference information for the bubble effect;
a generation unit for generating control instruction information for the bubble effect representation apparatus based on a result of the analysis of the analysis unit; and
a representation unit for representing the bubble effect based on the control instruction information.

10. The bubble effect representation apparatus of claim 9, wherein the information related to the bubble effect comprises at least one of information about whether or not the bubble effect is used and a playback time of the bubble effect.

11. The bubble effect representation apparatus of claim 9, wherein the analysis unit combines first metadata generated based on the information related to the bubble effect, second metadata generated based on the information about the performance of the bubble effect representation apparatus, and third metadata generated based on the preference information for the bubble effect.

12. The bubble effect representation apparatus of claim 11, wherein the first metadata comprises information about an intensity of the bubble effect and range information for the intensity of the bubble effect.

13. The bubble effect representation apparatus of claim 11, wherein the second metadata comprises information about whether or not the bubble effect is able to be represented.

14. The bubble effect representation apparatus of claim 11, wherein, the third metadata comprises information about whether or not the bubble effect is used according to the user's preference information for the bubble effect.

15. The bubble effect representation apparatus of claim 14, wherein:
the generation unit generates the metadata for control of the bubble effect representation apparatus based on the control instruction information, and
the representation unit drives the bubble effect representation apparatus by analyzing the metadata for control of the bubble effect representation apparatus.

16. An apparatus for generating control of a bubble effect representation apparatus, comprising:
a generation unit for generating first metadata for a bubble effect based on information related to the bubble effect, generating second metadata for a performance of the bubble effect representation apparatus based on information about the performance of the bubble effect representation apparatus, and generating third metadata related to a user's preference information for the bubble effect based on preference information for the bubble effect; and
an analysis unit for combining the first metadata, the second metadata, and the third metadata and analyzing the combined metadata,
wherein the generation unit generates metadata for control of the bubble effect representation apparatus based on a result of the analysis of the analysis unit.

17. The apparatus of claim 16, wherein the information related to the bubble effect comprises at least one of information about whether or not the bubble effect is used and a playback time of the bubble effect.

18. The apparatus of claim 16, wherein the first metadata comprises information about an intensity of the bubble effect and range information for the intensity of the bubble effect, the second metadata comprises information about whether or not the bubble effect is able to be represented, and the third metadata comprises information about whether or not the bubble effect is used according to the user's preference information for the bubble effect.
